(19) United States
(12) Patent Application Publication
(10) Pub. No.: US 2023/0266502 A1
(43) Pub. Date: Aug. 24, 2023

(54) COLLABORATIVE OPTIMIZATION METHOD FOR GAS INJECTION HUFF-N-PUFF PARAMETERS IN TIGHT OIL RESERVOIRS

(71) Applicant: China University of Petroleum (East China), Qingdao (CN)

(72) Inventors: Chuanjin YAO, Qingdao (CN); Yaqian LIU, Qingdao (CN); Baishuo LIU, Qingdao (CN); Jia ZHAO, Qingdao (CN); Kai ZHANG, Qingdao (CN); Zhe WANG, Qingdao (CN); Lei LI, Qingdao (CN); Jingxuan HOU, Qingdao (CN)

(73) Assignee: China University of Petroleum (East China), Qingdao (CN)

(21) Appl. No.: 18/074,679

(22) Filed: Dec. 5, 2022

(30) Foreign Application Priority Data
Feb. 24, 2022 (CN) 2022101752630

(51) Int. Cl. G01V 99/00; G06F 17/11; E21B 43/16

(52) U.S. Cl. CPC G01V 99/005; G06F 17/11; E21B 43/168; E21B 2200/20

(57) ABSTRACT

The invention provides a collaborative optimization method for gas injection huff-n-puff parameters in tight oil reservoirs. The method relates to the technical field of oilfield development parameter optimization, including: (1) establishing the numerical simulation model that accurately describes the actual oil reservoirs; (2) determining the optimization parameters of gas injection huff-n-puff, giving the optimization range of gas injection huff-n-puff parameters and other variable constraints, and establishing an optimization objective function; and (3) using the particle swarm optimization algorithm to solve the objective function constructed based on a collaborative optimization model for gas injection huff-n-puff parameters. Then the optimal gas injection rate, gas injection time, soaking time, and production time after the collaborative optimization for gas injection huff-n-puff parameters of the reservoir are obtained.

### CROSS-REFERENCE TO RELATED APPLICATIONS

The application claims priority to Chinese patent application No. 2022101752630, filed on Feb. 24, 2022, the entire contents of which are incorporated herein by reference.

### TECHNICAL FIELD

The invention relates to the field of oilfield development parameter optimization technology, in particular to a collaborative optimization method for gas injection huff-n-puff parameters in tight oil reservoirs.

### BACKGROUND

In recent years, with the decrease of conventional resources, unconventional resources have played an increasingly important role in crude oil production. Low permeability and ultra-low permeability reservoirs, such as tight reservoirs, are vigorously developed based on the combination of horizontal wells and multi-stage fracturing technology. A large number of experimental and numerical simulation investigations show that gas injection huff-n-puff based on horizontal well and hydraulic fracturing technology shows great potential. Different gas injection parameters can obtain different development effects. The determination of gas injection huff-n-puff parameters is very important to enhance oil recovery. The existing optimization method for gas injection parameters is single factor analysis to optimize each gas injection parameter in turn. However, due to the mutual influence and restriction between different gas injection parameters, the combination of gas injection parameters determined by single factor analysis often cannot get a better development effect, which makes the optimization results not comprehensive. At present, the collaborative optimization for gas injection huff-n-puff parameters is generally conducted based on the traditional orthogonal design method. The simulation schemes of different gas injection huff-n-puff parameters are carried out, and the orthogonal design results are analyzed to determine the optimal gas injection huff-n-puff parameter scheme. The orthogonal experimental design is orthogonal and can greatly reduce the number of experimental schemes by simplifying the comprehensive experimental design. However, it is difficult to find the optimal global solution effectively. It is possible to find the global optimal solution when the range of parameter optimization is further subdivided to select more levels in the optimization range. However, in this case, the number of optimization schemes will greatly increase, which greatly increases the time and labor cost for parameter optimization. The method fails to achieve finding the global optimal gas injection huff-n-puff parameters efficiently and quickly.

At present, the existing technologies for the optimization of gas injection huff-n-puff parameters in tight oil reservoirs mainly have the following shortcomings: (1) Most of them are conducted based on conceptual numerical simulation models or ideal experiments, which cannot accurately characterize the actual situation of the reservoirs, so the optimization results have little guiding effect on the exploitation of actual low permeability and ultra-low permeability reservoirs. (2) Single factor analysis is generally carried out to optimize gas injection rate, gas injection time, soaking time, and production time. However, the interaction between different gas injection huff-n-puff parameters and the synergistic effect on cumulative oil production or net present value are not considered, so that the optimization results are not comprehensive. (3) The collaborative optimization for gas injection huff-n-puff parameters using the orthogonal experimental design method frequently fails to obtain the global optimal solution quickly and efficiently.

### SUMMARY

The embodiment of the invention provides a collaborative optimization method for gas injection huff-n-puff parameters in tight oil reservoirs. Based on the reservoir numerical simulation model after production history matching, the particle swarm optimization algorithm is used to carry out the collaborative optimization for gas injection huff-n-puff parameters. This method not only fully considers the interaction between various parameters, but can also quickly and efficiently determine the global optimal solution of gas injection huff-n-puff parameters, which can provide theoretical guidance for the development of actual reservoirs.

In view of the above problems, the technical scheme of the invention is:

A collaborative optimization method for gas injection huff-n-puff parameters in tight oil reservoirs, including the following steps:

Step 1, establishing a numerical simulation model that conforms to the actual reservoirs;

Step 2, selecting the optimization parameters of gas injection huff-n-puff, giving the optimization range of gas injection huff-n-puff parameters and other variable constraints, and establishing the optimization objective function;

Step 3, based on the collaborative optimization model of gas injection huff-n-puff parameters, the particle swarm optimization algorithm is used to solve the objective function. Then the optimal gas injection rate, gas injection time, soaking time, and production time are obtained.

As a preferred technical scheme of the invention, the numerical simulation model conforming to the actual reservoirs as described in Step 1 is a numerical simulation model after fracturing flowback fitting and production history matching.

As a preferred technical scheme of the invention, Step 2 includes:

(1) Optimization range of gas injection huff-n-puff parameters is represented as: x_{i,min}≤xᵢ≤x_{i,max};

Where xᵢ is the value of the i^{th} gas injection huff-n-puff parameter, x_{i,min} is the lower limit of the i^{th} gas injection huff-n-puff parameter, and x_{i,max} . . . is the upper limit of the i^{th} gas injection huff-n-puff parameter;

(2) The variable constraint, such as the constraint representation of oil recovery is: RF≥RFₘᵢₙ;

Where RFₘᵢₙ is lower limit of oil recovery for optimizing numerical simulation schemes;

(3) The net present value or oil recovery is selected as the objective function of gas injection huff-n-puff parameter optimization;

1) Net Present Value:

$$max : NPV = {\sum }_{t = 1}^{{N}_{t}} [ \frac{1}{{( 1 + b )}^{t}} ( {\sum }_{i = 1}^{{N}_{p}} {r}_{op} {q}_{op}^{i , t} + {\sum }_{i = 1}^{{N}_{p}} {r}_{gp} {q}_{gp}^{i , t} - {\sum }_{i = 1}^{{N}_{p}} {c}_{gi} {q}_{gi}^{i , t} ) ] ;$$

2) Oil Recovery:

$$max : RF = {\sum }_{t = 1}^{{N}_{t}} ( {\sum }_{i = 1}^{{N}_{p}} {q}_{op}^{i , t} ) / N ;$$

Where qₒₚ^{i,t} is the oil production of the i^{th} well in the i^{th} year; q_{gp}^{i,t} is the gas production of the i^{th} well in the t^{th} year; q_{gi}^{i,t} is the gas injection volume of the i^{th} well in the t^{th} year; rₒₚ and r_{gp} are sales prices of oil and gas, respectively; c_{gi} is the gas injection cost; Nₜ is evaluation time, year; Nₚ is the number of evaluation wells; b is the discount rate, %; N is original oil in place.

As a preferred technical scheme of the invention, the particle swarm optimization algorithm is used to solve the objective function to obtain the optimal gas injection rate, gas injection time, soaking time, and production time in Step 3. The specific steps include:

(1) Each particle is randomly initialized using the particle swarm optimization algorithm, including initial velocity and position;

(2) Based on the parameter sequence, the reservoir numerical simulator is automatically called to run the simulation schemes;

(3) The simulation results are automatically read to calculate the optimization objective function. Each particle is evaluated to determine the current individual extremum and the global optimal solution of the swarm:

(4) The velocity and position of each particle are updated according to the updating formula of particle velocity and position, and the objective function value of the updated particle is calculated;

(5) The historical optimal position of each particle and the global optimal solution of the swarm are updated;

(6) Determine whether the optimization has reached the termination condition. If it does, the global optimal solution of the gas injection huff-n-puff parameter is obtained. If not, continue to update the particle velocity and position, generate a new parameter sequence, and return to Step (2).

As a preferred technical scheme of the invention, the termination condition described in Step (6) is met when the maximum number of iterations is reached or the deviation of calculation results between two adjacent generations is less than 0.1%.

Compared with the existing technology, the beneficial effect of the invention is: On one hand, the collaborative optimization method for gas injection huff-n-puff parameters in tight oil reservoirs is proposed based on a numerical simulation model accurately describing the actual reservoirs and fracturing conditions. The numerical simulation model is established and adjusted according to the actual reservoir characteristics and production historical data of the target reservoirs. The optimization for gas injection huff-n-puff parameters is carried out based on the numerical simulation model to make the optimization results more instructive. On the other hand, the collaborative optimization method for gas injection huff-n-puff parameters, combining the particle swarm optimization algorithm, is faster and more efficient for determining the optimal gas injection huff-n-puff parameters.

The above description is only an overview of the technical scheme of the invention. In order to understand the technical means of the invention more clearly so that the technical scheme can be implemented according to the content of the specification, and in order to make the above and other purposes, characteristics, and advantages of the invention more easily understood, the following is the specific implementation method of the invention.

### BRIEF DESCRIPTION OF DRAWINGS

FIG. 1 is a flow chart of the collaborative optimization method for gas injection huff-n-puff parameters based on the particle swarm optimization algorithm in the embodiment of the invention;

FIG. 2 shows a three-dimensional numerical simulation model after correction in the embodiment of the invention;

FIG. 3 is the flow chart of optimizing gas injection huff-n-puff parameters based on the orthogonal design method in the embodiment of the invention;

FIG. 4 shows the collaborative optimization results for gas injection huff-n-puff parameters based on the particle swarm optimization method in the implementation of the invention;

FIG. 5 is a flow diagram of a collaborative optimization method for gas injection huff-n-puff parameters in tight oil reservoirs disclosed in the embodiment of the invention.

### DETAILED DESCRIPTION OF THE EMBODIMENTS

In the following, the technical scheme of the embodiment of the invention will be clearly and completely described in combination with the drawings of the embodiment of the invention. Obviously, the embodiment described is only a part of the embodiment of the invention, not the whole embodiment.

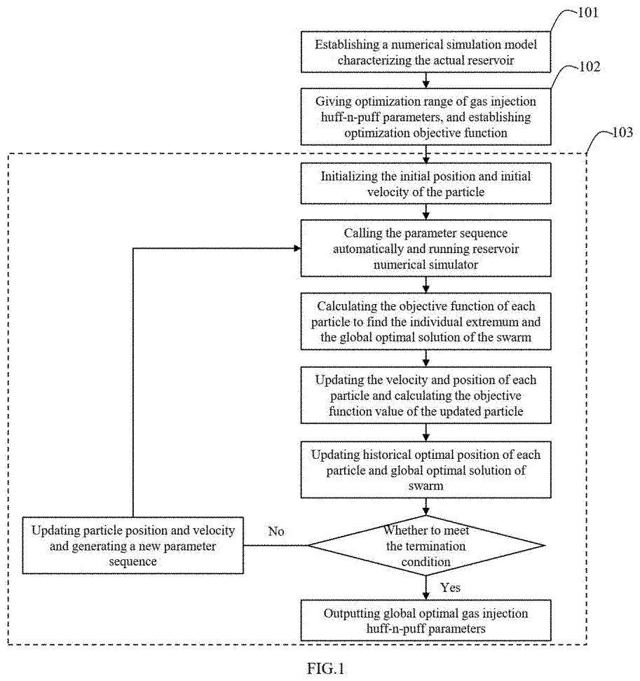

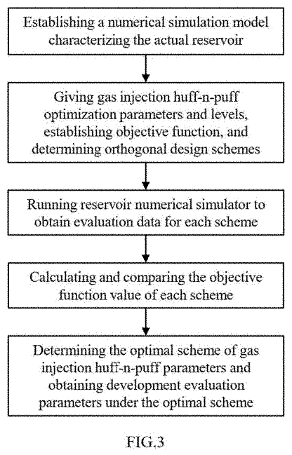

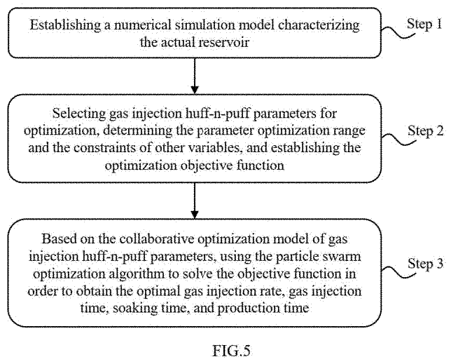

As shown in FIG. 1-5, a collaborative optimization method for gas injection huff-n-puff parameters in tight oil reservoirs includes the following steps:

Step 1, establishing a numerical simulation model that conforms to the actual reservoirs;

The numerical simulation model conforming to the actual reservoirs in Step 1 refers to a numerical simulation model fitted by fracturing flowback and production history data. Therefore, the numerical simulation model can accurately characterize the geological characteristics, fracturing conditions, and production effects of the actual reservoir.

Step 2, determining the gas injection huff-n-puff optimization parameters, giving the optimization range of gas injection huff-n-puff parameters and the constraints of other variables, and establishing the optimization objective function.

Step 2 includes:

(1) The optimization range of gas injection huff-n-puff parameters is represented as: x_{i,min}≤xᵢ≤x_{i,max};

Where xᵢ is the value of the i^{th} gas injection huff-n-puff parameter, x_{i,min} is the lower limit of the i^{th} gas injection huff-n-puff parameter, and x_{i,max} . . . is the upper limit of the i^{th} gas injection huff-n-puff parameter;

(2) The variable constraint, such as the constraint representation of oil recovery is: RF≥RFₘᵢₙ;

Where RFₘᵢₙ is lower limit of oil recovery for optimizing numerical simulation schemes;

(3) The net present value or oil recovery is selected as the objective function of gas injection huff-n-puff parameter optimization;

1) Net Present Value:

$$max : NPV = {\sum }_{t = 1}^{{N}_{t}} [ \frac{1}{{( 1 + b )}^{t}} ( {\sum }_{i = 1}^{{N}_{p}} {r}_{op} {q}_{op}^{i , t} + {\sum }_{i = 1}^{{N}_{p}} {r}_{gp} {q}_{gp}^{i , t} - {\sum }_{i = 1}^{{N}_{p}} {c}_{gi} {q}_{gi}^{i , t} ) ] ;$$

2) Oil Recovery:

$$max : RF = {\sum }_{t = 1}^{{N}_{t}} ( {\sum }_{i = 1}^{{N}_{p}} {q}_{op}^{i , t} ) / N ;$$

Where qₒₚ^{i,t} is the oil production of the i^{th} well in the i^{th} year; q_{gp}^{i,t} is the gas production of the i^{th} well in the t^{th} year; q_{gi}^{i,t} is the gas injection volume of the i^{th} well in the t^{th} year; rₒₚ and r_{gp} are sales prices of oil and gas, respectively; c_{gi} is the gas injection cost; Nₜ is evaluation time, year; Nₚ is the number of evaluation wells; b is the discount rate, %; N is original oil in place.

Step 3, Based on the collaborative optimization model of gas injection huff-n-puff parameters, the particle swarm optimization algorithm is used to solve the objective function. Then the optimal gas injection rate, gas injection time, soaking time, and production time are obtained.

In Step 3, the particle swarm optimization algorithm is used to solve the objective function, and the optimal gas injection rate, gas injection time, soaking time, and production time are obtained. The specific steps include:

(1) using the particle swarm optimization algorithm to initialize each particle randomly, including initial velocity and initial position;

(2) calling the reservoir numerical simulator automatically based on the parameter sequence, and running the simulation schemes;

(3) automatically reading the simulation results, calculating the optimization objective function, evaluating each particle, and obtaining the current individual extremum and group global optimal solution;

(4) updating the velocity and position of each particle according to the updating formula of particle velocity and position, and calculating the objective function value of the updated particle;

(5) updating the historical optimal position of each particle and the global optimal solution of the swarm;

(6) determining whether the optimization has reached the termination condition. If it does, the global optimal solution of gas injection parameters is obtained. If not, continue to update the particle velocity and position, generate a new parameter sequence, and return to Step (2).

The termination condition described in Step (6) is met when the maximum number of iterations is reached or the deviation of calculation results between two adjacent generations is less than 0.1%.

### EMBODIMENT

As shown in FIG. 1, the process of collaborative optimization for gas injection huff-n-puff parameters in tight oil reservoirs mainly includes the following steps:

Step 101, Based on the dynamic and static data of the reservoir, a numerical simulation model conforming to the actual reservoir is established. Combined with the actual reservoir characteristics, fluid properties and field monitoring data, the reservoir geological model and fluid model are established. Combined with the actual fracturing construction parameters and production dynamic data, the multi-stage volumetric fracturing of the model is created. Moreover, the fracturing flowback and production history matching are carried out to correct the numerical simulation model, so as to obtain the numerical simulation model conforming to the actual reservoir.

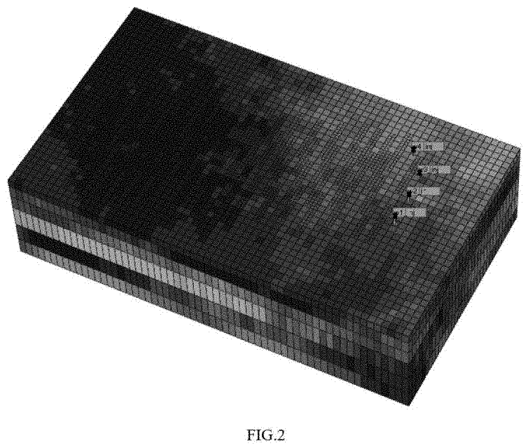

The domain of the numerical simulation model was discretized into 34×60×6 Cartesian grid blocks with a dimension of 50×50×11.16 m. The original reservoir pressure is 15.6 MPa, the temperature is 65° C., and the initial water saturation is 0.35. The matrix permeability and matrix porosity have strong heterogeneity. The detailed parameters of the numerical simulation model are shown in Table 1, and the three-dimensional diagram of the corrected numerical simulation model is shown in FIG. 2.

TABLE 1
The detailed parameters of the numerical simulation model

| Parameters | Value |
|---|---|
| Matrix porosity/% | 0.1-15 |
| Matrix permeability/(10⁻³ μm²) | 0.001-0.3 |
| Surface crude oil density/(g/cm³) | 0.8379 |
| Volume factor | 1.442 |
| Natural fracture spacing/m | 1 |
| Natural fracture permeability/(10⁻³ μm²) | 10 |
| Natural fracture porosity/% | 0.1 |
| Halflength of artificial fracture/m | 150 |
| Artificial fracture conductivity/(mD · m) | 200 |

Step 102: The optimization parameters of gas injection huff-n-puff are selected. The optimization range of gas injection huff-n-puff parameters and the constraint conditions of other variables are determined. The optimization objective function is established. Based on the fitted reservoir numerical simulation model, the parameters that have a great impact on the development effect of gas injection huff-n-puff in tight oil reservoirs were selected for collaborative optimization, including gas injection rate, gas injection time, soaking time, and production time. Under the premise of ensuring simulation accuracy and speed, the numerical simulation model was split to reduce the optimization time. The constraints of gas injection huff-n-puff parameters and other variables are shown in Table 2.

TABLE 2
The constraint conditions of gas injection huff-
n-puff parameters for collaborative optimization

| Variables | The range of variable constraint |
|---|---|
| Gas injection rate/(m³/d) | 800-4000 |
| Gas injection time/d | 10-90 |
| Soaking time/d | 0-45 |
| Production time/d | 60-180 |
| Oil recovery/% | >15 |

Considering that the economic benefits of gas injection puff-n-puff are crucial to the development of unconventional reservoirs such as tight reservoirs, the net present value is selected as the optimization objective function. The formula is:

$$max : NPV = {\sum }_{t = 1}^{{N}_{t}} [ \frac{1}{{( 1 + b )}^{t}} ( {\sum }_{i = 1}^{{N}_{p}} {r}_{op} {q}_{op}^{i , t} + {\sum }_{i = 1}^{{N}_{p}} {r}_{gp} {q}_{gp}^{i , t} - {\sum }_{i = 1}^{{N}_{p}} {c}_{gi} {q}_{gi}^{i , t} ) ] \qquad ( 1 )$$

Where qₒₚ^{i,t} is the oil production of the i^{th} well in the i^{th} year; q_{gp}^{i,t} is the gas production of the i^{th} well in the t^{th} year; q_{gi}^{i,t} is the gas injection volume of the i^{th} well in the t^{th} year; rₒₚ and r_{gp} are sales prices of oil and gas, respectively. The price of crude oil is set at 467 dollars/ton, and the price of injected natural gas is 330 dollars/ton; c_{gi} is the gas injection cost; Nₜ is evaluation time and is set as ten years here; Nₚ is the number of evaluation wells; b is the discount rate and is set as 10% here; N is original oil in place.

Step 103, based on the collaborative optimization model for gas injection huff-n-puff parameters, the particle swarm optimization algorithm is used to solve the objective function to obtain the optimal gas injection rate, gas injection time, soaking time, and production time.

(1) Collaborative Optimization for Gas Injection Huff-n-Puff Parameters Based on the Particle Swarm Optimization Method

1) using particle swarm optimization algorithm to randomly initialize each particle, including initial velocity and initial position;

2) based on the parameter sequence, automatically calling the reservoir numerical simulator to run the simulation schemes:

3) automatically reading the simulation results, calculating the optimization objective function of each particle, evaluating each particle and obtaining the current individual extremum and group global optimal solution:

4) The velocity and position of each particle are updated according to the updating formula of particle velocity and position, and the objective function value of the updated particle is calculated. The position of the i^{th} particle is updated according to formula (2) and its velocity is calculated according to formula (3);

vᵢ=ω*vᵢ+c₁rand₁(pᵢ−xᵢ)+c₂rand₂(gᵢ−xᵢ) (2)

xᵢ=xᵢ+vᵢ (3)

Where w is the inertia factor; c₁ is an individual learning factor and c₂ is a group learning factor; rand₁ and rand₂ are random factors ranging from 0 to 1; pᵢ is the individual extremum, which is the optimal position searched by a single particle till now; gᵢ is the global extremum, which is the optimal position searched by the whole particle swarm till now;

5) updating the historical optimal position of each particle and the global optimal solution of the swarm;

6) determining whether the optimization termination conditions are reached. The termination conditions generally refer that the maximum number of iterations is met or the deviation of calculation results between the two adjacent generations is less than 0.1%. If the termination condition is satisfied, the global optimal gas injection huff-n-puff parameter solution is obtained. Otherwise, continue to update the particle velocity and position, generate a new parameter sequence, and return to Step 2.

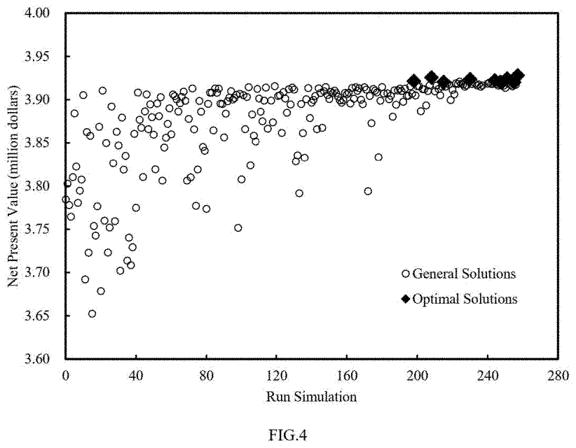

Based on the numerical simulation model, the net present value of gas injection huff-n-puff development for ten years is taken as the objective function. The particle swarm optimization algorithm is used to collaboratively optimize the gas injection huff-n-puff parameters. The scatter diagram of the calculated results is shown in FIG. 4. Table 3 lists the top ten huff-n-puff parameter schemes in terms of net present value.

TABLE 3
The top ten optimal gas injection huff-n-puff parameter schemes

| | Gas | Gas | | | |
|---|---|---|---|---|---|
| | injection | injection | Production | Soaking | Net present |
| Schemes | rate(m³/d) | time(d) | time(d) | time(d) | value(dollars) |
| 1 | 3970 | 90 | 175 | 0 | 3928095.78 |
| 2 | 3991 | 90 | 171 | 0 | 3925898.97 |
| 3 | 3983 | 90 | 172 | 0 | 3924635.81 |
| 4 | 4000 | 90 | 174 | 0 | 3923770.82 |
| 5 | 3977 | 90 | 173 | 0 | 3922425.27 |
| 6 | 3988 | 88 | 174 | 0 | 3921738.77 |
| 7 | 4000 | 90 | 175 | 0 | 3920667.83 |
| 8 | 4000 | 90 | 176 | 0 | 3920530.53 |
| 9 | 4000 | 87 | 175 | 0 | 3920201.01 |
| 10 | 4000 | 87 | 174 | 0 | 3919953.87 |

From Table 3 and FIG. 4, it can be obtained that the collaborative optimization method for gas injection huff-n-puff parameters based on the particle swarm optimization algorithm could determine the optimal combination of gas injection huff-n-puff parameters. The gas injection rate was 3970 m³/d, the gas injection time was 90 d, the soaking time was 0 d, and the production time was 175 d. The predicted net present value is 3.9281 million dollars by mining for ten years with the optimal parameter combination.

(2) Collaborative Optimization for Gas Injection Huff-n-Puff Parameters Based on an Orthogonal Design Method

At the same time, based on numerical simulation technology, a conventional orthogonal design method was carried out to collaboratively optimize gas injection parameters, including gas injection rate, gas injection time, soaking time and production time. Four levels are selected for each factor. The specific orthogonal design table L₁₆ (4⁵) is shown in Table 4. The orthogonal test simulation results of the optimization for gas injection buff-n-puff parameters are shown in Table 5. The optimal combination of gas injection huff-n-puff parameters is determined as shown in Table 6.

TABLE 4
Orthogonal test design for gas injection
huff-n-puff parameter optimization

Levels

| Parameters | 1 | 2 | 3 | 4 |
|---|---|---|---|---|
| Gas injection rate(m³/d) | 1000 | 2000 | 3000 | 4000 |
| Gas injection time(d) | 10 | 30 | 60 | 90 |
| Soaking time(d) | 5 | 15 | 30 | 45 |
| Production time(d) | 60 | 90 | 150 | 180 |

TABLE 5
Simulation results of the orthogonal design method for
gas injection huff-n-puff parameter optimization

| | Gas | Gas | | | |
|---|---|---|---|---|---|
| | Injection | injection | Soaking | Production | Net present |
| Schemes | rate(m³/d) | time(d) | time(d) | time(d) | value(dollars) |
| 1 | 1000 | 10 | 5 | 60 | 3222206.97 |
| 2 | 1000 | 30 | 15 | 90 | 3240454.19 |
| 3 | 1000 | 60 | 30 | 150 | 3228989.61 |
| 4 | 1000 | 90 | 45 | 180 | 3210316.75 |
| 5 | 2000 | 10 | 15 | 150 | 3232998.78 |
| 6 | 2000 | 30 | 5 | 180 | 3368088.64 |
| 7 | 2000 | 60 | 45 | 60 | 3209753.82 |
| 8 | 2000 | 90 | 30 | 90 | 3347493.58 |
| 9 | 3000 | 10 | 30 | 180 | 3251918.77 |
| 10 | 3000 | 30 | 45 | 150 | 3390578.45 |
| 11 | 3000 | 60 | 5 | 90 | 3605069.13 |
| 12 | 3000 | 90 | 15 | 60 | 3452143.95 |
| 13 | 4000 | 10 | 45 | 90 | 3276042.45 |
| 14 | 4000 | 30 | 30 | 60 | 3441832.69 |
| 15 | 4000 | 60 | 15 | 180 | 3752337.54 |
| 16 | 4000 | 90 | 5 | 150 | 3846305.93 |

TABLE 6
The optimal combination of gas injection huff-n-puff
parameters determined by the orthogonal design method

| | Gas | Gas | | | |
|---|---|---|---|---|---|
| Param- | injection | injection | Soaking | Production | Net present |
| eters | rate(m³/d) | time(d) | time(d) | time(d) | value(dollars) |
| Value | 4000 | 90 | 5 | 150 | 3846305.93 |

From the orthogonal design results of gas injection huff-n-puff parameters optimization, it can be seen that the net present value with the parameters and level combination of scheme 16 is the largest and the mining effect is the best. The optimal combination of gas injection huff-n-puff parameters is the gas injection rate of 4000 m³/d, the gas injection time of 90 d, the soaking time of 5 d, and the production time of 150 d. The net present value is 3.8463 million dollars, and the oil recovery is 25.02%.

(3) Comparison of Optimization Results Between Two Methods

The optimization results of the orthogonal design method and particle swarm optimization algorithm are compared, and the specific parameter values and prediction results are shown in table 7.

TABLE 7
Comparison of optimization results between the two methods

| Optimization | Orthogonal | Particle swarm |
|---|---|---|
| parameters | design method | optimization method |
| Gas injection | 4000 | 3970 |
| rate(m³/d) | | |
| Gas injection | 90 | 90 |
| time(d) | | |
| Soaking time(d) | 5 | 0 |
| Production time(d) | 150 | 175 |
| Net present value | 3.8463 | 3.9281 |
| (million dollars) | | |

By comparing the net present value under the optimal gas injection huff-n-puff parameters optimized by the particle swarm optimization algorithm and the orthogonal design method, it can be seen that the particle swarm optimization algorithm can obtain the global optimal solution while the orthogonal design method only obtains the local optimal solution. It is possible to obtain the global optimal solution when the parameter optimization range is further refined to increase the number of orthogonal design levels. However, in this case, the increasing experimental design schemes cause the optimization time and labor cost to be greatly increased. It is difficult to quickly and efficiently determine the global optimal gas injection huff-n-puff parameter combination. Therefore, the collaborative optimization method of gas injection parameters based on the particle swarm optimization algorithm has more advantages than the traditional orthogonal design method.

In this paper, a collaborative optimization method for gas injection huff-n-puff parameters in tight oil reservoirs is proposed. A numerical simulation model is established based on the reservoir characteristics and production historical data, which can accurately characterize the actual reservoir and fracturing conditions. The optimization for gas injection huff-n-puff parameters based on the corrected numerical simulation model is carried out to make the optimization results more instructive. The optimal gas injection huff-n-puff parameter level determined by the conventional orthogonal design method is only a local optimal solution, and the invention can find the global optimal gas injection huff-n-puff parameter based on the particle swarm optimization algorithm. Even if the level number of each factor in the orthogonal design is increased and the parameter optimization range is further subdivided, it is possible to find the global optimal solution. However, in this case, the number of optimization schemes will be greatly increased, which greatly increases the time cost of parameter optimization. Therefore, the collaborative optimization method for gas injection huff-n-puff parameters based on particle swarm optimization is faster and more efficient.

Obviously, technicians in this field can make various modifications and variations to the invention without breaking away from the spirit and scope of the invention. In this way, if these modifications and variants of the invention belong to the scope of the invention's claim and its equivalent technology, the invention also intends to include these modifications and variants.

What is claimed is:

1. A collaborative optimization method for gas injection huff-n-puff parameters in tight oil reservoirs is characterized by the following steps:
Step 1, establishing a numerical simulation model that accurately describes the actual reservoirs;
Step 2, determining the optimization parameters of gas injection huff-n-puff, giving the optimization range of gas injection huff-n-puff parameters and the constraints of other variables, and establishing the optimization objective function;
Step 3, based on the collaborative optimization model of gas injection huff-n-puff parameters, the particle swarm optimization algorithm is used to solve the objective function to obtain the optimal gas injection rate, gas injection time, soaking time, and production time.

2. According to a collaborative optimization method for gas injection huff-n-puff parameters in tight oil reservoirs as described in claim 1, its characteristics are as follows: The numerical simulation model in Step 1 that conforms to the actual oil reservoirs is a numerical simulation model after fracturing flowback fitting and production history matching.

3. According to a collaborative optimization method for gas injection huff-n-puff parameters in tight oil reservoirs as described in claim 1, Step 2 comprises:
(1) Optimization range of gas injection huff-n-puff parameters is represented as: x_{i,min}≤xᵢ≤x_{i,max};
Where xᵢ is the value of the i^{th} gas injection huff-n-puff parameter, x_{i,min} is the lower limit of the i^{th} gas injection huff-n-puff parameter, and x_{i,max} . . . is the upper limit of the i^{th} gas injection huff-n-puff parameter;
(2) The variable constraint, such as the constraint representation of oil recovery is: RF≥RFₘᵢₙ;
Where RFₘᵢₙ is lower limit of oil recovery for optimizing numerical simulation schemes;
(3) The net present value or oil recovery is selected as the objective function of gas injection huff-n-puff parameter optimization;
1) Net Present Value:
$$max : NPV = {\sum }_{t = 1}^{{N}_{t}} [ \frac{1}{{( 1 + b )}^{t}} ( {\sum }_{i = 1}^{{N}_{p}} {r}_{op} {q}_{op}^{i , t} + {\sum }_{i = 1}^{{N}_{p}} {r}_{gp} {q}_{gp}^{i , t} - {\sum }_{i = 1}^{{N}_{p}} {c}_{gi} {q}_{gi}^{i , t} ) ] ; \qquad ( 1 )$$
2) Oil Recovery:
$$max : RF = {\sum }_{t = 1}^{{N}_{t}} ( {\sum }_{i = 1}^{{N}_{p}} {q}_{op}^{i , t} ) / N ;$$
Where qₒₚ^{i,t} is the oil production of the i^{th} well in the i^{th} year; q_{gp}^{i,t} is the gas production of the i^{th} well in the t^{th} year; q_{gi}^{i,t} is the gas injection volume of the i^{th} well in the t^{th} year; rₒₚ and r_{gp} are sales prices of oil and gas, respectively; c_{gi} is the gas injection cost; Nₜ is evaluation time, year; Nₚ is the number of evaluation wells; b is the discount rate, %; N is original oil in place.

4. According to a collaborative optimization method for gas injection huff-n-puff parameters in tight oil reservoirs as described in claim 1, its characteristics are as follows: The particle swarm optimization algorithm is used to solve the objective function to obtain the optimal gas injection rate, gas injection time, soaking time, and production time in Step 3; The specific steps include:
(1) The particle swarm optimization method is used to perform random initialization of each particle, including initial velocity and initial position;
(2) The reservoir numerical simulator is automatically called based on parameter sequence to run simulation schemes;
(3) The simulation results are automatically read to calculate the optimization objective function, evaluate each particle and obtain the current individual extremum and group global optimal solution;
(4) The velocity and position of each particle are updated according to the particle velocity and position update formulas, and the objective function value of the updated particle is calculated;
(5) The historical optimal position of each particle and the global optimal solution of the swarm are updated;
(6) Judge whether the optimization has reached the termination condition; If it does, the global optimal solution of the gas injection huff-n-puff parameter is obtained; If not, continue to update the particle velocity and position, generate a new parameter sequence, and return to Step (2).

5. According to a collaborative optimization method for gas injection huff-n-puff parameters in tight oil reservoirs as described in claim 4, its characteristics are as follows: The termination condition described in Step (6) is that the maximum number of iterations has been reached or that the difference in calculation results between two adjacent generations is less than 0.1%.
